(19) United States
(12) Patent Application Publication
(10) Pub. No.: US 2025/0071635 A1
(43) Pub. Date: Feb. 27, 2025

(54) METHODS AND APPARATUS OF TCI STATE APPLICATION DURING L1/L2 BASED INTER-CELL MOBILITY

(71) Applicant: GUANGDONG OPPO MOBILE TELECOMMUNICATIONS CORP., LTD., Dongguan (CN)

(72) Inventor: Li GUO, Allen, TX (US)

(21) Appl. No.: 18/944,824

(22) Filed: Nov. 12, 2024

Related U.S. Application Data
(63) Continuation of application No. PCT/IB2023/057126, filed on Jul. 12, 2023.

(30) Foreign Application Priority Data
Jul. 12, 2022 (US) 63388491

(51) Int. Cl. H04W 36/00; H04W 36/08

(52) U.S. Cl. CPC H04W 36/0072; H04W 36/0085; H04W 36/08

(57) ABSTRACT

Disclosed is a method for enabling a terminal device to perform a handover process. The method includes (1) receiving, by a terminal device from a network device of a first serving cell, Radio Resource Control (RRC) configuration information for a second serving cell, wherein the RRC configuration information includes one or more Transmission Configuration Indicator (TCI) states associated with the second serving cell; (2) receiving, by the terminal device, a high-layer parameter to indicate a first TCI state of the one or more TCI states for switching to the second serving cell; (3) receiving, by the terminal device, a handover command to switch to the second serving cell; and (4) switching, by the terminal device, to the second serving cell.

### CROSS-REFERENCE TO RELATED APPLICATION(S)

This application is a Continuation Application of International Patent Application No. PCT/IB2023/057126 filed on Jul. 12, 2023, which claims the benefit of priority of U.S. Provisional Patent Application Ser. No. 63/388,491, filed Jul. 12, 2022, which are incorporated by reference herein in their entireties.

### TECHNICAL FIELD

The present disclosure relates to systems and methods for indicating Transmission Configuration Indicator (TCI) state. More specifically, systems and methods for TCI state indication and switch for inter-cell mobility are provided.

### BACKGROUND

New Radio (NR) and fifth generation (5G) systems support RRM (radio resource management) measurements. Conventional systems can request a user equipment (UE) to measure Synchronization Signals (SS) and Physical Broadcast Channel (PBCH) Blocks (SSBs) and/or Channel State Information Reference Signal (CSI-RS) for mobility of multiple neighbor cells. The UE reports the measurement result to the system. The reported measurements are used by the system to determine inter-cell mobility.

However, drawbacks of the conventional systems include that they have large latency and high signaling overhead, which impair systems' performance (especially for high mobility UEs). Therefore, improved systems and methods that can address the foregoing issues are desirable and beneficial.

### SUMMARY

The present disclosure is related to systems and methods for indicating and applying TCI state on downlink (DL) and unlink (UL) channels during Layer-1 (L1)/Layer-2 (L2) inter-cell mobility in a framework of unified TCI framework.

In some embodiments, a terminal device (e.g., a UE) can be indicated by a base station (e.g., gNB) of a first serving cell to switch to a second serving cell. For the second serving cell, the UE can be provided with a set of RRC (Radio Resource Control) configurations. For example, the UE can be provided with a first TCI state that is associated with the second serving cell. When the UE is requested to switch to the second serving cell, the UE can be requested to apply the RRC configurations associated with the second serving cell. The UE can also be requested to apply the first TCI state for reception of downlink channels of the second serving cell and/or transmission of uplink channels towards to the second serving cell.

In some embodiments, the gNB can use a first higher layer parameter to indicate the UE to apply the first TCI state with. For example, the gNB can indicate the UE to apply the first TCI state on common PDCCH (Physical Downlink Control Channel) and associated PDSCH (Physical Downlink Shared Channel). For example, the gNB can indicate the UE to apply the first TCI state on a PDCCH and an associated PDSCH, as well as a PUCCH (Physical Uplink Control Channel) and an associated PUSCH (Physical Uplink Shared Channel).

In some embodiments, the present method can be implemented by a tangible, non-transitory, computer-readable medium having processor instructions stored thereon that, when executed by one or more processors, cause the one or more processors to perform one or more aspects/features of the method described herein. In other embodiments, the present method can be implemented by a system comprising a computer processor and a non-transitory computer-readable storage medium storing instructions that when executed by the computer processor cause the computer processor to perform one or more actions of the method described herein.

### BRIEF DESCRIPTION OF THE DRAWINGS

To describe the technical solutions in the implementations of the present disclosure more clearly, the following briefly describes the accompanying drawings. The accompanying drawings show merely some aspects or implementations of the present disclosure, and a person of ordinary skill in the art may still derive other drawings from these accompanying drawings without creative efforts.

FIG. 1 is a schematic diagram of a wireless communication system in accordance with one or more implementations of the present disclosure.

FIG. 2 is a schematic block diagram of a terminal device in accordance with one or more implementations of the present disclosure.

FIG. 3 is a flowchart of a method in accordance with one or more implementations of the present disclosure.

FIG. 4 is a flowchart of a method in accordance with one or more implementations of the present disclosure.

### DETAILED DESCRIPTION

To describe the technical solutions in the implementations of the present disclosure more clearly, the following briefly describes the accompanying drawings. The accompanying drawings show merely some aspects or implementations of the present disclosure, and a person of ordinary skill in the art may still derive other drawings from these accompanying drawings without creative efforts.

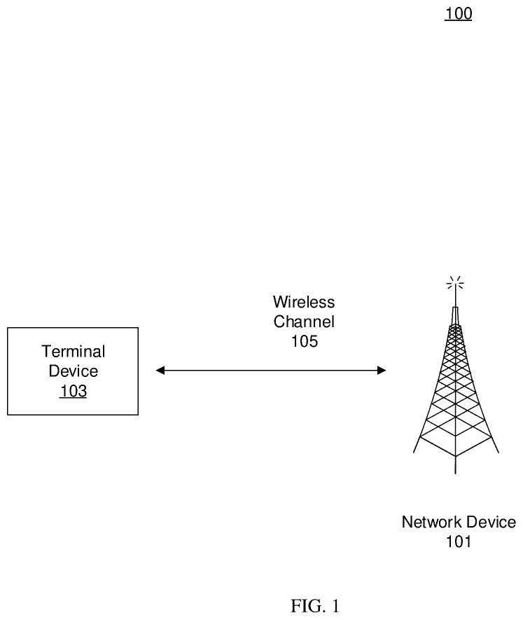

FIG. 1 is a schematic diagram of a wireless communication system 100 in accordance with one or more implementations of the present disclosure. The wireless communication system 100 can implement the methods discussed herein for measuring phase difference of reference signal resources. As shown in FIG. 1, the wireless communications system 100 includes a network device (or base station/cell) 101.

Examples of the network device 101 include a base transceiver station (Base Transceiver Station, BTS), a NodeB (NodeB, NB), an evolved Node B (eNB or eNodeB), a Next Generation NodeB (gNB or gNode B), a Wireless Fidelity (Wi-Fi) access point (AP), etc. In some embodiments, the network device 101 can include a relay station, an access point, an in-vehicle device, a wearable device, and the like. The network device 101 can include wireless connection devices for communication networks such as: a Global System for Mobile Communications (GSM) network, a Code Division Multiple Access (CDMA) network, a Wideband CDMA (WCDMA) network, an LTE network, a cloud radio access network (Cloud Radio Access Network, CRAN), an Institute of Electrical and Electronics Engineers (IEEE) 802.11-based network (e.g., a Wi-Fi network), an Internet of Things (IoT) network, a device-to-device (D2D) network, a next-generation network (e.g., a 5G network), a future evolved public land mobile network (Public Land Mobile Network, PLMN), or the like. A 5G system or network can be referred to as an NR system or network.

The embodiments of the present disclosure provide a method, and the method includes: receiving, by a terminal device from a network device of a first serving cell, Radio Resource Control (RRC) configuration information for a second serving cell, where the RRC configuration information includes one or more Transmission Configuration Indicator (TCI) states associated with the second serving cell; receiving, by the terminal device, a high-layer parameter to indicate a first TCI state of the one or more TCI states for switching to the second serving cell; receiving, by the terminal device, a handover command to switch to the second serving cell; and switching, by the terminal device, to the second serving cell.

In some embodiments, the method further includes: applying the first TCI state according to the high-layer parameter.

In some embodiments, the method further includes: applying the first TCI state on reception of downlink (DL) channels and reference signals (RSs) of the second serving cell.

In some embodiments, the method further includes: applying the first TCI state on transmission of uplink (UL) channels and reference signals (RSs) of the second serving cell.

In some embodiments, the method further includes: receiving, by the terminal device, the handover command through a Media Access Control (MAC) Control Element (CE) command.

In some embodiments, the method further includes: receiving, by the terminal device, the handover command through a Downlink Control Information (DCI) signal.

The embodiments of the present disclosure provide a method, and the method includes: receiving, by a terminal device, a list of candidate serving cells and a set of Radio Resource Control (RRC) configuration information and measurement conditions for each of the candidate serving cells; receiving, by the terminal device, a Transmission Configuration Indicator (TCI) state for each of the candidate serving cells; performing, by the terminal device, a Layer-1 (L1) measurement on each of the candidate serving cells based on the measurement conditions; and determining, by the terminal device, a serving cell for handover from the list of candidate serving cells.

In some embodiments, the method further includes: reporting, by the terminal device, the determined serving cell for handover for handover to a network device.

In some embodiments, the method further includes: initiating, by the terminal device, a handover process to switch to the determined serving cell for handover by applying the TCI state of the determined serving cell for handover.

In some embodiments, the method further includes: receiving, by the terminal device, a high-layer parameter to indicate the TCI state.

In some embodiments, the method further includes: applying the TCI state according to the high-layer parameter.

In some embodiments, the method further includes: applying the TCI state on reception of downlink (DL) channels and reference signals (RSs) of the determined serving cell for handover.

In some embodiments, the method further includes: receiving, by the terminal device, a handover command through a Media Access Control (MAC) Control Element (CE) command.

In FIG. 1, the wireless communications system 100 also includes a terminal device 103. The terminal device 103 can be an end-user device configured to facilitate wireless communication. The terminal device 103 can be configured to wirelessly connect to the network device 101 (via, e.g., via a wireless channel 105) according to one or more corresponding communication protocols/standards.

The terminal device 103 may be mobile or fixed. The terminal device 103 can be a user equipment (UE), an access terminal, a user unit, a user station, a mobile site, a mobile station, a remote station, a remote terminal, a mobile device, a user terminal, a terminal, a wireless communications device, a user agent, or a user apparatus. Examples of the terminal device 103 include a modem, a cellular phone, a smartphone, a cordless phone, a Session Initiation Protocol (SIP) phone, a wireless local loop (WLL) station, a personal digital assistant (PDA), a handheld device having a wireless communication function, a computing device or another processing device connected to a wireless modem, an in-vehicle device, a wearable device, an Internet-of-Things (IoT) device, a device used in a 5G network, a device used in a public land mobile network, or the like. For illustrative purposes, FIG. 1 illustrates only one network device 101 and one terminal device 103 in the wireless communications system 100. However, in some instances, the wireless communications system 100 can include additional network device 101 and/or terminal device 103.

The terminal device 103 can be requested (e.g., by the network device 101) to measure and report a phase of received positioning reference signals. The terminal device 103 can be provided with a configuration of positioning reference signals by the network device 101 e.g., a location server, a server with LMF (location management function), a base station (e.g., a gNB), etc.

The terminal device 103 can be indicated by the network device 101 of a first serving cell to switch to a second serving cell. For the second serving cell, the terminal device 103 can be provided with a set of RRC configurations. For example, the terminal device 103 can be provided with a first TCI state that is associated with the second serving cell. When the terminal device 103 is requested to switch to the second serving cell, the terminal device 103 can be requested to apply the RRC configurations associated with the second serving cell. The terminal device 103 can also be requested to apply the first TCI state for reception of downlink channels of the second serving cell and/or transmission of uplink channels towards to the second serving cell.

In some embodiments, the network device 101 can use a first higher layer parameter to indicate the terminal device 103 to apply the first TCI state with. For example, the network device 101 can indicate the terminal device 103 to apply the first TCI state on common PDCCH and associated PDSCH. For example, the network device 101 can indicate the terminal device 103 to apply the first TCI state on a PDCCH and an associated PDSCH, as well as a PUCCH and an associated PUSCH.

### First Set of Embodiments

In some embodiments, the network device 101 can provide a higher layer parameter (e.g., the first higher layer parameter) with one or more of the following alternatives.

(1) The network device 101 can provide a value of the first higher layer parameter through RRC signaling.

(2) The network device 101 can associate one candidate cell identification (ID) with one value of the first higher layer parameter. When the terminal device 103 switches to a cell identified by a first cell ID, the terminal device 103 can be requested to apply the first TCI state according to a “mode” indicated by the value of the first higher layer parameter associated with the first cell ID.

(3) The network device 101 can provide a value of the first higher layer parameter in a handover command, for example, an MAC (Media Access Control) CE (Control Element) handover command. When the terminal device 103 switches to a cell according to this handover command, the terminal device 103 can be requested to apply the first TCI state according to the “mode” indicated by the indicated value of the first higher layer parameter.

(4) The network device 101 can associate a value of the first higher layer parameter with a TCI state. When a first TCI state is indicated for handover, the terminal device 103 can be requested to apply the first TCI state according to the “mode” indicated by the value of the first higher layer parameter associated with the first TCI state.

In some embodiments, the terminal device 103 can be provided with a list of joint TCI states that are associated with a second serving cell. Each joint TCI state can contain one or more RS (Reference Signal) providing reference for QCL (Quasi co-location) configuration for reception of downlink channels/reference signals. In the joint TCI state, the RS used to provide reference for QCL-typeD also provides reference for determining uplink TX (transmission) spatial filter for uplink transmission.

The terminal device 103 can be indicated with a first joint TCI state and the terminal device 103 is requested to apply the first joint TCI state when the terminal device 103 switches to the second serving cell. In one example, the first joint TCI state can be indicated to the terminal device 103 through an MAC CE message. The first joint TCI state can be indicated to the terminal device 103 through a DCI (Downlink Control Information) signaling. The first joint TCI state can be indicated in the handover command signaling. When the terminal device 103 switches to the second serving cell, the terminal device 103 can be requested to apply the first joint TCI state on reception of downlink channels/RSs and/or transmission of uplink channels/RS. The network device 101 can indicate/configure a first higher layer parameter that indicates the terminal device 103 how to apply the first joint TCI state.

In one example, the network device 101 can use the first higher layer parameter to indicate the terminal device 103 to apply the first joint TCI state on the reception of all the PDCCH and the PDSCH. The network device can also use the first higher layer parameter to indicate the terminal device 103 to apply the first joint TCI state on the reception of CSI-RS resource that is configured to follow/use the indicated TCI state.

In one example, the network device 101 can use the first higher layer parameter to indicate the terminal device 103 to apply the first joint TCI state on the reception of common PDCCH and corresponding PDSCH. The benefit of the foregoing methods includes that the handover only involves the common channels and the terminal device 103 is still able to receive UE-specific PDCCH and PDSCH from any TRP (transmission/reception point).

For example, when the terminal device 103 switches to the second serving cell, the network device 101 can use the first higher layer parameter to indicate the terminal device 103 to apply the first joint TCI state on the reception of PDCCH in a Control Resource Set (CORESET) with index “0” and corresponding PDSCH and apply the first joint TCI state on the reception of PDCCH in the CORESET, other than a CORESET with index “0,” associated with only CSS (Common Search Space) set other than Type3-PDCCH CSS sets and the corresponding PDSCH.

In one example, the network device 101 can use the first higher layer parameter to indicate the terminal device 103 to apply the first joint TCI state on the transmission of PUSCH and PUCCH. The network device 101 can use the first higher layer parameter to indicate the terminal device 103 to apply the first joint TCI state on the transmission of SRS resource that is configured to follow the indicated TCI state, such as the SRS resource configured with higher layer parameter “useIndicatedTCIState.”

In some embodiments, the terminal device 103 can be provided with a list of DL TCI states that are associated with a second serving cell. Each DL TCI state contains one or more RS providing reference for QCL configuration for reception of downlink channels/reference signals. The terminal device 103 can be indicated with a first DL TCI state and the terminal device 103 is requested to apply the first DL TCI state when the terminal device 103 switches to the second serving cell.

In one example, the first DL TCI state can be indicated to the terminal device 103 through an MAC CE message. The first DL TCI state can be indicated to the terminal device 103 through a DCI signaling. The first DL TCI state can be indicated in the handover command signaling. When the terminal device 103 switches to the second serving cell, the terminal device 103 can be requested to apply the first DL TCI state on reception of downlink channels/RSs. The network device 101 can indicate/configure a first higher layer parameter that indicates the terminal device 103 how to apply the first DL TCI state.

In one example, the network device 101 can use the first higher layer parameter to indicate the terminal device 103 to apply the first DL TCI state on the reception of all the PDCCH and the PDSCH. The network device 101 can use the first higher layer parameter to indicate the terminal device 103 to apply the first DL TCI state on the reception of CSI-RS resource that is configured to follow/use the indicated TCI state.

In one example, the network device 101 can use the first higher layer parameter to indicate the terminal device 103 to apply the first DL TCI state on the reception of common PDCCH and corresponding PDSCH. The benefit of this example includes that the handover only involves the common channels and the terminal device 103 is still able to receive UE-specific PDCCH and PDSCH from any TRP. For example, when the terminal device 103 switches to the second serving cell, the terminal device 103 can be requested to apply the first DL TCI state on the reception of PDCCH in a CORESET with index “0” and corresponding PDSCH and apply the first joint TCI state on the reception of PDCCH in a CORESET, other than a CORESET with index “0,” associated with only CSS set other than Type3-PDCCH CSS sets and the corresponding PDSCH.

In some implementations, the terminal device 103 can be provided with a list of DL TCI states and a list of UL TCI states that are associated with a second serving cell. Each DL TCI state contains one or more RS providing reference for QCL configuration for reception of downlink channels/reference signals and each UL TCI state contains one RS providing reference for determining uplink TX spatial filter for uplink transmission. The terminal device 103 can be indicated with a first DL TCI state and a second UL TCI state and the terminal device 103 is requested to apply the first DL TCI state and/or the second UL TCI state when the terminal device 103 switches to the second serving cell.

In one example, the first DL TCI state and the second UL TCI state can be indicated to the UE through an MAC CE message. The first DL TCI state and the second UL TCI state can be indicated to the terminal device 103 through a DCI signaling. The first DL TCI state and the second UL TCI state can be indicated in the handover command signaling. When the terminal device 103 switches to the second serving cell, the terminal device 103 can be requested to apply the first DL TCI state on reception of downlink channels/RSs and/or the second UL TCI state on the transmission of uplink channels/RS. The network device 101 can indicate/configure a first higher layer parameter that indicates the terminal device 103 how to apply the first DL TCI state and the second UL TCI state.

In one example, the network device 101 can use the first higher layer parameter to indicate the UE to apply the first DL TCI state on the reception of all the PDCCH and the PDSCH. The network device 101 can use the first higher layer parameter to indicate the terminal device 103 to apply the first DL TCI state on the reception of CSI-RS resource that is configured to follow/use the indicated TCI state.

In one example, the network device 101 can use the first higher layer parameter to indicate the UE to apply the first DL TCI state on the reception of common PDCCH and corresponding PDSCH. The benefit of this example includes that the handover only involves the common channels and the terminal device 103 is still able to receive UE-specific PDCCH and PDSCH from any TRP. For example, when the terminal device 103 switches to the second serving cell, the terminal device 103 can be requested to apply the first DL TCI state on the reception of PDCCH in a CORESET with index “0” and corresponding PDSCH and apply the first DL TCI state on the reception of PDCCH in a CORESET, other than a CORESET with index “0,” associated with only CSS set other than Type3-PDCCH CSS sets and the corresponding PDSCH.

In one example, the network device 101 can use the first higher layer parameter to indicate the terminal device 103 to apply the second UL TCI state on the transmission of PUSCH and PUCCH. The terminal device 103 can also be requested to apply the second UL TCI state on the transmission of SRS resource that is configured to follow the indicated TCI state, for example, the SRS resource configured with higher layer parameter “useIndicatedTCIState.”

In one embodiment, the terminal device 103 can be configured to operate a UE-initiated L1/L2 inter-cell handover. The terminal device 103 can be provided with a list of candidates serving cells and for each candidate serving cell, the terminal device 103 can be provided with a set of RRC configuration. The terminal device 103 can also be provided with a condition for measurement. The terminal device 103 can conduct L1 measurement on those candidate serving cells. When the configured condition for measurement is met, the terminal device 103 can choose one from the configured list of candidates serving cells and the terminal device 103 can initiate the handover to the selected candidate serving cell.

The terminal device 103 can be requested to report the selected candidate serving cell to the system (e.g., the network device 101). For each candidate serving cell, the network device 101 can provide one TCI state to the terminal device 103 and the terminal device 103 can be requested to apply the provided TCI state on the reception of downlink channels/RS and/or transmission of uplink channels/RSs when the terminal device 103 switches to one serving cell.

In one example, when the terminal device 103 determines one candidate serving cell for handover, the terminal device 103 can also determine one TCI state that is going to be used when the terminal device 103 switches to the selected candidate serving cell. The terminal device 103 can report the selected TCI state to the network device 101. The network device 101 can use a first higher layer parameter to indicate the terminal device 103 to apply the selected TCI state with a given method.

For example, the network device 101 can indicate the terminal device 103 to apply the selected TCI state on common PDCCH and associated PDSCH. For example, the network device 101 can indicate the terminal device 103 to apply the selected TCI state on all the PDCCH and associated PDSCH (and the PUSCH/PUCCH). For example, the network device 101 can indicate the terminal device 103 to apply the selected TCI state on CSI-RS resource and/or SRS resource that are configured to follow indicated TCI state. The terminal device 103 can be requested to apply the selected TCI state on particular channels/reference signals according to the indicated value of the first higher layer parameter. The network device 101 can indicate one mode of applying the selected TCI state to the terminal device 103 through the first higher layer parameter.

### Second Set of Embodiments

In some embodiments, the network device 101 can provide the first higher layer parameter with one or more of the following alternatives.

(1) The network device 101 can provide a value of the first higher layer parameter through RRC signaling.

(2) The network device 101 can associate a cell ID with one value of the first higher layer parameter. When the terminal device 103 switches to a cell identified by a first cell ID, the terminal device 103 can apply the selected TCI state according to the “mode” indicated by the value of the first higher layer parameter associated with the first cell ID.

(3) The network device 101 can provide a value of the first higher layer parameter in a handover command, for example an MAC CE handover command. When the terminal device 103 switches to a cell according to this handover command, the terminal device 103 can be requested to apply the first TCI state according to the “mode” indicated by the indicated value of the first higher layer parameter.

(4) The network device 101 can associate a value of the first higher layer parameter with a TCI state. When a first TCI state is selected for handover, the terminal device 103 can be requested to apply the first TCI state according to the “mode” indicated by the value of the first higher layer parameter associated with the first TCI state.

In some embodiments, the terminal device 103 can be configured with a first list of physical cell IDs and those physical cell IDs are the IDs of candidate serving cell that the terminal device 103 can handover to. For each of those physical cell ID, the terminal device 103 can be provided with a set of RRC configuration. If the terminal device 103 handovers to a serving cell with a first physical cell ID, the terminal device 103 applies the corresponding RRC configuration. For each physical cell ID, the terminal device 103 can also be provided with a list of TCI states that are associated with this physical cell ID, where the TCI state can include one or more of the followings.

[1] A joint TCI state in which one or more RSs are included to provided reference for QCL configuration. The RS configured for QCL-TypeD can also provide reference for determining UL Tx spatial filter for uplink transmission. Each joint TCI state can also be associated with a set of power control parameters for PUSCH, for PUCCH or SRS.

[2] A DL TCI state in which one or more RSs are included to provide reference for QCL configuration.

[3] A UL TCI state in which one RS is included to provide reference for determining UL Tx spatial filter for uplink transmission. Each UL TCI state can also be associated with a set of power control parameters for PUSCH, PUCCH or SRS.

The terminal device 103 can be provided with a configuration of handover condition, for example, a threshold for reference signal RSRP (Reference Signal Received Power) of the serving cell and a threshold of reference signal RSRP of candidate serving cell. When the condition is met, the terminal device 103 can determine to handover to the serving cell with a physical cell ID in the first list of physical cell IDs. The terminal device 103 can be requested to determine TCI state for receive downlink channels/RS and/or transmit uplink channel/RS after the terminal device 103 handovers to the determined serving cell. The terminal device 103 can be requested to determine one joint TCI state. The terminal device 103 can be requested to determine one DL TCI state. The terminal device 103 can be requested to determine one DL TCI state and one UL TCI state.

In one example, for a first physical cell ID in the first list of physical cell IDs, the network device 101 can indicate TCI state that is associated with the first physical cell ID. When the terminal device 103 handovers to the serving cell of the first physical cell ID, the terminal device 103 can apply the indicated TCI state that is associated with the first physical cell ID on reception of downlink channels/RSs and/or transmission of uplink channels/RSs after the terminal device 103 handovers to one serving cell with the first physical cell ID.

The indicated TCI state can be a joint TCI state. The terminal device 103 can be requested to apply the indicated joint TCI state on the reception of all the PDCCH and the PDSCH after the terminal device 103 handovers to the serving cell of the first physical cell ID. The terminal device 103 can also be requested to apply the indicated joint TCI state on the reception of CSI-RS resource that is configured to follow/use the indicated TCI state. In one example, the terminal device 103 can be requested to apply the indicated joint TCI state on the reception of common PDCCH and corresponding PDSCH. The benefit of this example includes that the handover only involves the common channels and the terminal device 103 is still able to receive UE-specific PDCCH and PDSCH from any TRP. For example, when the terminal device 103 switches to the serving cell of the first physical cell ID, the terminal device 103 can be requested to apply the first joint TCI state on the reception of PDCCH in a CORESET with index “0” and corresponding PDSCH and apply the first joint TCI state on the reception of PDCCH in a CORESET, other than a CORESET with index “0,” associated with only CSS set other than Type3-PDCCH CSS sets and the corresponding PDSCH.

In one example, the terminal device 103 can be requested to apply the indicated joint TCI state on the transmission of PUSCH and PUCCH. The terminal device 103 can also be requested to apply the indicated joint TCI state on the transmission of SRS resource that is configured to follow the indicated TCI state, for example if the SRS resource is configured with higher layer parameter “useIndicatedTCIState.”

The indicated TCI state can be a DL TCI state. The terminal device 103 can be requested to apply the indicated DL TCI state on the reception of all the PDCCH and the PDSCH after the terminal device 103 handovers to the serving cell of the first physical cell ID. The terminal device 103 can also be requested to apply the indicated DL TCI state on the reception of CSI-RS resource that is configured to follow/use the indicated TCI state. In one example, the terminal device 103 can be requested to apply the indicated DL TCI state on the reception of common PDCCH and corresponding PDSCH. The benefit of this example includes that the handover only involves the common channels and the terminal device 103 is still able to receive UE-specific PDCCH and PDSCH from any TRP. For example, when the terminal device 103 switches to the serving cell of the first physical cell ID, the terminal device 103 can be requested to apply the indicated DL TCI state on the reception of PDCCH in a CORESET with index “0” and corresponding PDSCH and apply the indicated DL TCI state on the reception of PDCCH in a CORESET, other than a CORESET with index “0,” associated with only CSS set other than Type3-PDCCH CSS sets and the corresponding PDSCH.

The indicated TCI state can be a DL TCI state and a UL TCI state. The terminal device 103 can be requested to apply the indicated DL TCI state on the reception of all the PDCCH and the PDSCH after the terminal device 103 handovers to the serving cell of the first physical cell ID. The terminal device 103 can also be requested to apply the indicated DL TCI state on the reception of CSI-RS resource that is configured to follow/use the indicated TCI state. In one example, the terminal device 103 can be requested to apply the indicated DL TCI state on the reception of common PDCCH and corresponding PDSCH. The benefit of this example includes that the handover only involves the common channels and the terminal device 103 is still able to receive UE-specific PDCCH and PDSCH from any TRP.

For example, when the UE switches to the serving cell of the first physical cell ID, the terminal device 103 can be requested to apply the indicated DL TCI state on the reception of PDCCH in a CORESET with index “0” and corresponding PDSCH and apply the indicated DL TCI state on the reception of PDCCH in a CORESET, other than a CORESET with index “0,” associated with only CSS set other than Type3-PDCCH CSS sets and the corresponding PDSCH. In one example, the terminal device 103 can be requested to apply the indicated UL TCI state on the transmission of PUSCH and PUCCH. The terminal device 103 can also be requested to apply the indicated UL TCI state on the transmission of SRS resource that is configured to follow the indicated TCI state, for example if the SRS resource is configured with higher layer parameter “useIndicatedTCIState.”

In one example, for a first physical cell ID in the first list of physical cell IDs, the terminal device 103 can determine one joint TCI state, or a DL TCI state or one DL TCI state and one UL TCI state. When the terminal device 103 handovers to the serving cell of the first physical cell ID, the terminal device 103 can apply the determined TCI state(s) that is associated with the first physical cell ID on reception of downlink channels/RSs and/or transmission of uplink channels/RSs after the terminal device 103 handovers to one serving cell with the first physical cell ID. The terminal device 103 can be requested to report the determined TCI state(s) to the network device 101.

For example, the terminal device 103 can report the ID of the determined joint TCI state to the network device 101. The terminal device 103 can report that in an MAC CE message. The terminal device 103 can report that in a UCI (Uplink Control Information) message. The terminal device 103 can report that in an RRC signaling.

For example, the terminal device 103 can report the ID of the determined DL TCI state to the network device 101. The terminal device 103 can report that in an MAC CE message. The terminal device 103 can report that in a UCI message. The UE can report that in an RRC signaling.

For example, the terminal device 103 can report the ID of the determined DL TCI state and the ID of the determined UL TCI state to the network device 101. The terminal device 103 can report that in an MAC CE message. The terminal device 103 can report that in a UCI message. The terminal device 103 can report that in an RRC signaling.

For example, the terminal device 103 can report the ID of a reference signal that can be used as DL QCL to the network device 101. The terminal device 103 can report the ID of a reference signal that can be used to provide reference for UL Tx spatial filter to the network device. The terminal device 103 can report that in a MAC CE message. The terminal device 103 can report that in a UCI message. The terminal device 103 can report that in an RRC signaling.

With the determined joint TCI state, DL TCI state or UL TCI state, the terminal device 103 applies the determined TCI state when the terminal device 103 handovers to the serving cell of the first physical cell ID. The network device 101 can indicate the terminal device 103 with a first higher layer parameter that can indicate a “mode” of how the terminal device 103 shall apply the determined TCI state.

The determined TCI state can be a joint TCI state. The terminal device 103 can be requested to apply the indicated joint TCI state on the reception of all the PDCCH and the PDSCH after the terminal device 103 handovers to the serving cell of the first physical cell ID. The terminal device 103 can also be requested to apply the determined joint TCI state on the reception of CSI-RS resource that is configured to follow/use the determined TCI state. In one example, the terminal device 103 can be requested to apply the determined joint TCI state on the reception of common PDCCH and corresponding PDSCH. The benefit of this example includes that the handover only involves the common channels and the terminal device 103 is still able to receive UE-specific PDCCH and PDSCH from any TRP.

For example, when the terminal device 103 switches to the serving cell of the first physical cell ID, the terminal device 103 can be requested to apply the first joint TCI state on the reception of PDCCH in a CORESET with index “0” and corresponding PDSCH and apply the first joint TCI state on the reception of PDCCH in a CORESET, other than a CORESET with index “0,” associated with only CSS set other than Type3-PDCCH CSS sets and the corresponding PDSCH. In one example, the terminal device 103 can be requested to apply the determined joint TCI state on the transmission of PUSCH and PUCCH. The terminal device 103 can also be requested to apply the determined joint TCI state on the transmission of SRS resource that is configured to follow the determined TCI state, for example if the SRS resource is configured with higher layer parameter “useIndicatedTCIState.”

The determined TCI state can be a DL TCI state. The terminal device 103 can be requested to apply the determined DL TCI state on the reception of all the PDCCH and the PDSCH after the terminal device 103 handovers to the serving cell of the first physical cell ID. The terminal device 103 can also be requested to apply the determined DL TCI state on the reception of CSI-RS resource that is configured to follow/use the determined TCI state. In one example, the terminal device 103 can be requested to apply the determined DL TCI state on the reception of common PDCCH and corresponding PDSCH. The benefit of this example includes that the handover only involves the common channels and the terminal device 103 is still able to receive UE-specific PDCCH and PDSCH from any TRP.

For example, when the terminal device 103 switches to the serving cell of the first physical cell ID, the terminal device 103 can be requested to apply the determined DL TCI state on the reception of PDCCH in a CORESET with index “0” and corresponding PDSCH and apply the determined DL TCI state on the reception of PDCCH in a CORESET, other than a CORESET with index “0,” associated with only CSS set other than Type3-PDCCH CSS sets and the corresponding PDSCH.

The determined TCI state can be a DL TCI state and a UL TCI state. The terminal device 103 can be requested to apply the determined DL TCI state on the reception of all the PDCCH and the PDSCH after the terminal device 103 handovers to the serving cell of the first physical cell ID. The terminal device 103 can also be requested to apply the determined DL TCI state on the reception of CSI-RS resource that is configured to follow/use the determined TCI state. In one example, the terminal device 103 can be requested to apply the determined DL TCI state on the reception of common PDCCH and corresponding PDSCH. The benefit of this example includes that the handover only involves the common channels and the terminal device 103 is still able to receive UE-specific PDCCH and PDSCH from any TRP.

For example, when the terminal device 103 switches to the serving cell of the first physical cell ID, the terminal device 103 can be requested to apply the determined DL TCI state on the reception of PDCCH in a CORESET with index “0” and corresponding PDSCH and apply the determined DL TCI state on the reception of PDCCH in a CORESET, other than a CORESET with index “0,” associated with only CSS set other than Type3-PDCCH CSS sets and the corresponding PDSCH. In one example, the terminal device 103 can be requested to apply the determined UL TCI state on the transmission of PUSCH and PUCCH. The terminal device 103 can also be requested to apply the determined UL TCI state on the transmission of SRS resource that is configured to follow the determined TCI state, for example, the SRS resource configured with higher layer parameter “useIndicatedTCIState.”

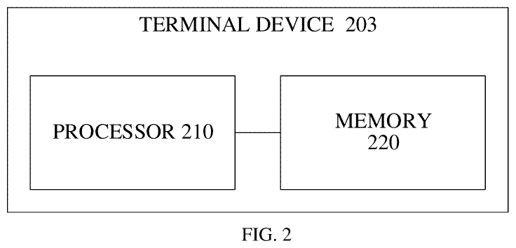

FIG. 2 is a schematic block diagram of a terminal device 203 (e.g., which can implement the methods discussed herein) in accordance with one or more implementations of the present disclosure. As shown, the terminal device 203 includes a processing unit 210 (e.g., a DSP, a CPU, a GPU, etc.) and a memory 220. The processing unit 210 can be configured to implement instructions that correspond to the methods discussed herein and/or other aspects of the implementations described above. It should be understood that the processor 210 in the implementations of this technology may be an integrated circuit chip and has a signal processing capability. During implementation, the steps in the foregoing method may be implemented by using an integrated logic circuit of hardware in the processor 210 or an instruction in the form of software. The processor 210 may be a general-purpose processor, a digital signal processor (DSP), an application specific integrated circuit (ASIC), a field programmable gate array (FPGA) or another programmable logic device, a discrete gate or transistor logic device, and a discrete hardware component. The methods, steps, and logic block diagrams disclosed in the implementations of this technology may be implemented or performed. The general-purpose processor 210 may be a microprocessor, or the processor 210 may be alternatively any conventional processor or the like. The steps in the methods disclosed with reference to the implementations of this technology may be directly performed or completed by a decoding processor implemented as hardware or performed or completed by using a combination of hardware and software modules in a decoding processor. The software module may be located at a random-access memory, a flash memory, a read-only memory, a programmable read-only memory or an electrically erasable programmable memory, a register, or another mature storage medium in this field. The storage medium is located at a memory 220, and the processor 210 reads information in the memory 220 and completes the steps in the foregoing methods in combination with the hardware thereof.

It may be understood that the memory 220 in the implementations of this technology may be a volatile memory or a non-volatile memory, or may include both a volatile memory and a non-volatile memory. The non-volatile memory may be a read-only memory (ROM), a programmable read-only memory (PROM), an erasable programmable read-only memory (EPROM), an electrically erasable programmable read-only memory (EEPROM) or a flash memory. The volatile memory may be a random-access memory (RAM) and is used as an external cache. For exemplary rather than limitative description, many forms of RAMs can be used, and are, for example, a static random-access memory (SRAM), a dynamic random-access memory (DRAM), a synchronous dynamic random-access memory (SDRAM), a double data rate synchronous dynamic random-access memory (DDR SDRAM), an enhanced synchronous dynamic random-access memory (ESDRAM), a synchronous link dynamic random-access memory (SLDRAM), and a direct Rambus random-access memory (DR RAM). It should be noted that the memories in the systems and methods described herein are intended to include, but are not limited to, these memories and memories of any other suitable type. In some embodiments, the memory may be a non-transitory computer-readable storage medium that stores instructions capable of execution by a processor.

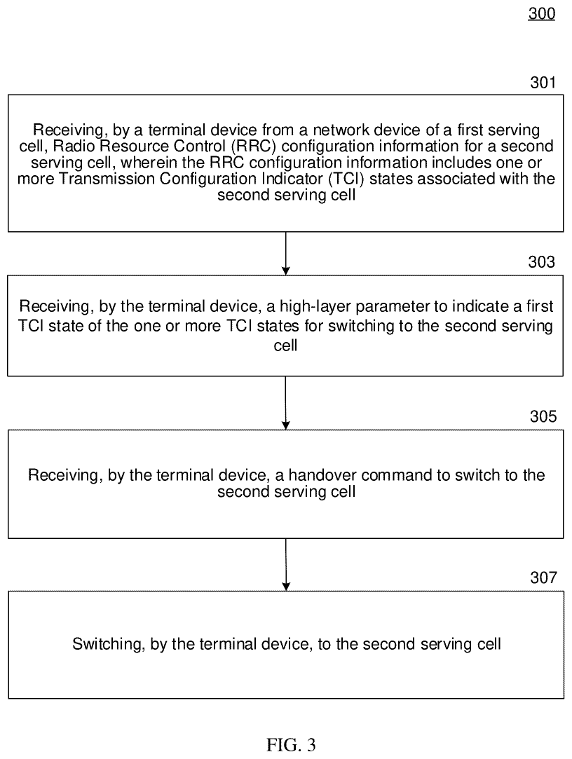

FIG. 3 is a flowchart of a method 300 in accordance with one or more implementations of the present disclosure. The method 300 can be implemented by a system (such as the wireless communications system 100). For example, the method 300 may also be implemented by the terminal device 103.

The method 300 includes, at block 301, receiving, by a terminal device from a network device of a first serving cell, Radio Resource Control (RRC) configuration information for a second serving cell. The RRC configuration information includes one or more Transmission Configuration Indicator (TCI) states associated with the second serving cell.

At block 303, the method 300 continues by receiving, by the terminal device, a high-layer parameter to indicate a first TCI state of the one or more TCI states for switching to the second serving cell. At block 305, the method 300 continues by receiving, by the terminal device, a handover command to switch to the second serving cell. At block 307, the method 300 continues by switching, by the terminal device, to the second serving cell.

In some embodiments, method 300 further comprises applying the first TCI state according to the high-layer parameter. In some embodiments, method 300 further comprises applying the first TCI state on reception of downlink (DL) channels and reference signals (RSs) of the second serving cell. In some embodiments, method 300 further comprises applying the first TCI state on transmission of uplink (UL) channels and reference signals (RSs) of the second serving cell.

In some embodiments, the high-layer parameter is a Layer-1 (L1) parameter. In some embodiments, the high-layer parameter is a Layer-2 (L2) parameter.

In some embodiments, method 300 further comprises receiving, by the terminal device, the handover command through a Media Access Control (MAC) Control Element (CE) command. In some embodiments, method 300 further comprises receiving, by the terminal device, the handover command through a Downlink Control Information (DCI) signal. In some embodiments, method 300 further comprises receiving, by the terminal device, the handover command through an RRC signal.

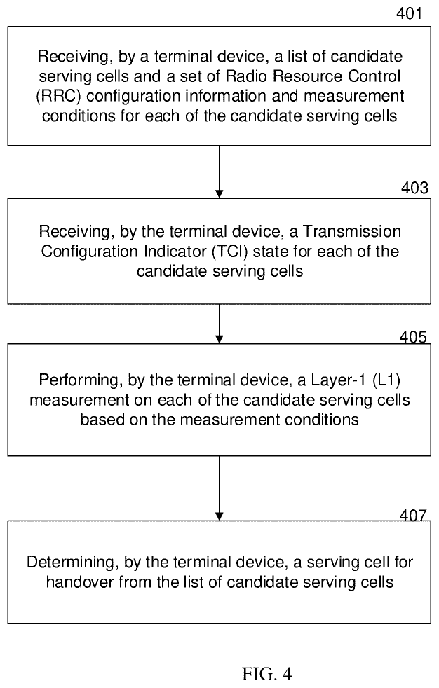

FIG. 4 is a flowchart of a method 400 in accordance with one or more implementations of the present disclosure. The method 400 can be implemented by a system (such as the wireless communications system 100). For example, the method 400 may also be implemented by the terminal device 103.

The method 400 includes, at block 401, receiving, by a terminal device, a list of candidate serving cells and a set of Radio Resource Control (RRC) configuration information and measurement conditions for each of the candidate serving cells.

At block 403, the method 400 continues by receiving, by the terminal device, a Transmission Configuration Indicator (TCI) state for each of the candidate serving cells. At block 405, the method continues by performing, by the terminal device, a Layer-1 (L1) measurement on each of the candidate serving cells based on the measurement conditions. At block 407, the method continues by determining, by the terminal device, a serving cell for handover from the list of candidate serving cells.

In some embodiments, the method 400 further comprises reporting, by the terminal device, the determined serving cell for handover for handover to a network device. In some embodiments, the method 400 can further include initiating, by the terminal device, a handover process to switch to the determined serving cell for handover by applying the TCI state of the determined serving cell for handover.

In some embodiments, the TCI state is indicated by a high-layer parameter. In some embodiments, the high-layer parameter is a Layer-1 (L1) parameter or a Layer-2 (L2) parameter. In some embodiments, the method 400 further comprises applying the TCI state according to the high-layer parameter.

In some embodiments, the method 400 further comprising applying the TCI state on reception of downlink (DL) channels and reference signals (RSs) of the determined serving cell for handover. In some embodiments, the method 400 further comprising receiving, by the terminal device, a handover command through a Media Access Control (MAC) Control Element (CE) command. In some embodiments, the method 400 further comprising receiving, by the terminal device, a handover command through a Downlink Control Information (DCI) signal.

### Additional Considerations

The above Detailed Description of examples of the disclosed technology is not intended to be exhaustive or to limit the disclosed technology to the precise form disclosed above. While specific examples for the disclosed technology are described above for illustrative purposes, various equivalent modifications are possible within the scope of the described technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative implementations or sub-combinations. Each of these processes or blocks may be implemented in a variety of different ways. Also, while processes or blocks are at times shown as being performed in series, these processes or blocks may instead be performed or implemented in parallel, or may be performed at different times. Further, any specific numbers noted herein are only examples; alternative implementations may employ differing values or ranges.

In the Detailed Description, numerous specific details are set forth to provide a thorough understanding of the presently described technology. In other implementations, the techniques introduced here can be practiced without these specific details. In other instances, well-known features, such as specific functions or routines, are not described in detail in order to avoid unnecessarily obscuring the present disclosure. References in this description to “an implementation/embodiment,” “one implementation/embodiment,” or the like mean that a particular feature, structure, material, or characteristic being described is included in at least one implementation of the described technology. Thus, the appearances of such phrases in this specification do not necessarily all refer to the same implementation/embodiment. On the other hand, such references are not necessarily mutually exclusive either. Furthermore, the particular features, structures, materials, or characteristics can be combined in any suitable manner in one or more implementations/embodiments. It is to be understood that the various implementations shown in the figures are merely illustrative representations and are not necessarily drawn to scale.

Several details describing structures or processes that are well-known and often associated with communications systems and subsystems, but that can unnecessarily obscure some significant aspects of the disclosed techniques, are not set forth herein for purposes of clarity. Moreover, although the following disclosure sets forth several implementations of different aspects of the present disclosure, several other implementations can have different configurations or different components than those described in this section. Accordingly, the disclosed techniques can have other implementations with additional elements or without several of the elements described below.

Many implementations or aspects of the technology described herein can take the form of computer- or processor-executable instructions, including routines executed by a programmable computer or processor. Those skilled in the relevant art will appreciate that the described techniques can be practiced on computer or processor systems other than those shown and described below. The techniques described herein can be implemented in a special-purpose computer or data processor that is specifically programmed, configured, or constructed to execute one or more of the computer-executable instructions described below. Accordingly, the terms “computer” and “processor” as generally used herein refer to any data processor. Information handled by these computers and processors can be presented at any suitable display medium. Instructions for executing computer- or processor-executable tasks can be stored in or on any suitable computer-readable medium, including hardware, firmware, or a combination of hardware and firmware. Instructions can be contained in any suitable memory device, including, for example, a flash drive and/or other suitable medium.

The term “and/or” in this specification is only an association relationship for describing the associated objects, and indicates that three relationships may exist, for example, A and/or B may indicate the following three cases: A exists separately, both A and B exist, and B exists separately.

These and other changes can be made to the disclosed technology in light of the above Detailed Description. While the Detailed Description describes certain examples of the disclosed technology, as well as the best mode contemplated, the disclosed technology can be practiced in many ways, no matter how detailed the above description appears in text. Details of the system may vary considerably in its specific implementation, while still being encompassed by the technology disclosed herein. As noted above, particular terminology used when describing certain features or aspects of the disclosed technology should not be taken to imply that the terminology is being redefined herein to be restricted to any specific characteristics, features, or aspects of the disclosed technology with which that terminology is associated. Accordingly, the invention is not limited, except as by the appended claims. In general, the terms used in the following claims should not be construed to limit the disclosed technology to the specific examples disclosed in the specification, unless the above Detailed Description section explicitly defines such terms.

A person of ordinary skill in the art may be aware that, in combination with the examples described in the implementations disclosed in this specification, units and algorithm steps may be implemented by electronic hardware, or a combination of computer software and electronic hardware. Whether the functions are performed by hardware or software depends on particular applications and design constraint conditions of the technical solutions. A person skilled in the art may use different methods to implement the described functions for each particular application, but it should not be considered that the implementation goes beyond the scope of this application.

Although certain aspects of the invention are presented below in certain claim forms, the applicant contemplates the various aspects of the invention in any number of claim forms. Accordingly, the applicant reserves the right to pursue additional claims after filing this application to pursue such additional claim forms, in either this application or in a continuing application.

What is claimed is:

1. A method, comprising:
receiving, by a terminal device from a network device of a first serving cell, Radio Resource Control (RRC) configuration information for a second serving cell, wherein the RRC configuration information includes one or more Transmission Configuration Indicator (TCI) states associated with the second serving cell;
receiving, by the terminal device, a high-layer parameter to indicate a first TCI state of the one or more TCI states for switching to the second serving cell;
receiving, by the terminal device, a handover command to switch to the second serving cell; and
switching, by the terminal device, to the second serving cell.

2. The method of claim 1, further comprising:
applying the first TCI state according to the high-layer parameter.

3. The method of claim 1, further comprising:
applying the first TCI state on reception of downlink (DL) channels and reference signals (RSs) of the second serving cell.

4. The method of claim 1, further comprising:
applying the first TCI state on transmission of uplink (UL) channels and reference signals (RSs) of the second serving cell.

5. The method of claim 1, further comprising:
receiving, by the terminal device, the handover command through a Media Access Control (MAC) Control Element (CE) command.

6. The method of claim 1, further comprising:
receiving, by the terminal device, the handover command through a Downlink Control Information (DCI) signal.

7. The method of claim 1, wherein the high-layer parameter is a Layer-1 (L1) parameter;
or the high-layer parameter is a Layer-2 (L2) parameter.

8. A method, comprising:
receiving, by a terminal device, a list of candidate serving cells and a set of Radio Resource Control (RRC) configuration information and measurement conditions for each of the candidate serving cells;
receiving, by the terminal device, a Transmission Configuration Indicator (TCI) state for each of the candidate serving cells;
performing, by the terminal device, a Layer-1 (L1) measurement on each of the candidate serving cells based on the measurement conditions; and
determining, by the terminal device, a serving cell for handover from the list of candidate serving cells.

9. The method of claim 8, further comprising:
reporting, by the terminal device, the determined serving cell for handover for handover to a network device.

10. The method of claim 8, further comprising:
initiating, by the terminal device, a handover process to switch to the determined serving cell for handover by applying the TCI state of the determined serving cell for handover.

11. The method of claim 8, further comprising:
receiving, by the terminal device, a high-layer parameter to indicate the TCI state.

12. The method of claim 11, further comprising:
applying the TCI state according to the high-layer parameter.

13. The method of claim 12, further comprising:
applying the TCI state on reception of downlink (DL) channels and reference signals (RSs) of the determined serving cell for handover.

14. The method of claim 8, further comprising:
receiving, by the terminal device, a handover command through a Media Access Control (MAC) Control Element (CE) command.

15. A system comprising:
a processor; and
a memory configured to store instructions, when executed by the processor, to:
receive, from a network device of a first serving cell, Radio Resource Control (RRC) configuration information for a second serving cell, wherein the RRC configuration information includes one or more Transmission Configuration Indicator (TCI) states associated with the second serving cell;
receive a high-layer parameter to indicate a first TCI state of the one or more TCI states for switching to the second serving cell;
receive a handover command to switch to the second serving cell; and
switch to the second serving cell.

16. The system of claim 15, wherein the memory is configured to the store instructions, when executed by the processor, to:
apply the first TCI state according to the high-layer parameter.

17. The system of claim 15, wherein the memory is configured to the store instructions, when executed by the processor, to:
apply the first TCI state on reception of downlink (DL) channels and reference signals (RSs) of the second serving cell.

18. The system of claim 15, wherein the memory is configured to the store instructions, when executed by the processor, to:
apply the first TCI state on transmission of uplink (UL) channels and reference signals (RSs) of the second serving cell.

19. The system of claim 15, wherein the memory is configured to the store instructions, when executed by the processor, to:
receive the handover command through a Media Access Control (MAC) Control Element (CE) command.

20. The system of claim 15, wherein the memory is configured to the store instructions, when executed by the processor, to:
receive the handover command through a Downlink Control Information (DCI) signal.
